(19) United States
(12) Patent Application Publication
(10) Pub. No.: US 2026/0029737 A1
(43) Pub. Date: Jan. 29, 2026

(54) PRINTED-MATTER SEALING PROCESSING SYSTEM AND METHOD AND NON-TRANSITORY COMPUTER READABLE MEDIUM

(71) Applicant: FUJIFILM BUSINESS INNOVATION CORP., Tokyo (JP)

(72) Inventor: Tomokazu KURITA, Kanagawa (JP)

(73) Assignee: FUJIFILM BUSINESS INNOVATION CORP., Tokyo (JP)

(21) Appl. No.: 19/056,040

(22) Filed: Feb. 18, 2025

(30) Foreign Application Priority Data
Jul. 26, 2024 (JP) 2024-120711

(51) Int. Cl. G03G 15/20; G03G 15/00

(52) U.S. Cl. CPC G03G 15/2064; G03G 15/6588; G03G 2215/00835

(57) ABSTRACT

A printed-matter sealing processing system includes a processor configured to: obtain a type of a printed matter to be sealed, the printed matter having being folded, a pressure adhesive toner being attached to the printed matter and exhibiting an adhesive function when pressure is applied to the pressure adhesive toner; and control an adhesion force to be applied when sealing the printed matter, in accordance with the obtained type of the printed matter.

### CROSS-REFERENCE TO RELATED APPLICATIONS

This application is based on and claims priority under 35 USC 119 from Japanese Patent Application No. 2024-120711 filed Jul. 26, 2024.

### BACKGROUND

### (i) Technical Field

The present disclosure relates to a printed-matter sealing processing system and method and a non-transitory computer readable medium.

### (ii) Related Art

Hitherto, a sealed postcard, which is generated by printing information on a sheet and then folding the sheet in two or more to be formed as a sealed document, is known. Such a sealed postcard is commonly used as a direct mail (DM) for sales promotion, for example. Since a sealed postcard is folded in two or more, more information can be contained at the same postage as a regular postcard. Additionally, the confidentiality of a sealed postcard is protected because the inside pages are unseen until the postcard is opened. A sealed postcard is thus suitable for sending personal information, for example.

Lately, a pressure adhesive toner having an adhesive function is widely used. Applying high pressure and heat to the pressure adhesive toner can cause a pressure-responsive resin contained in the toner to react, which makes the toner serve as an adhesive, such as a glue, to bind sheets. Using the pressure adhesive toner can eliminate a gluing step of applying an adhesive material to the inside pages of a printed matter.

### SUMMARY

It is convenient if the adhesion force to be applied when sealing a folded printed matter having a pressure adhesive toner attached thereto can be controlled in accordance with the type of printed matter.

Aspects of non-limiting embodiments of the present disclosure relate to a printed-matter sealing processing system and method that can control the adhesion force to be applied when sealing a folded printed matter having a pressure adhesive toner attached thereto in accordance with the type of printed matter.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a printed-matter sealing processing system including a processor configured to: obtain a type of a printed matter to be sealed, the printed matter having being folded, a pressure adhesive toner being attached to the printed matter and exhibiting an adhesive function when pressure is applied to the pressure adhesive toner; and control an adhesion force to be applied when sealing the printed matter, in accordance with the obtained type of the printed matter.

### BRIEF DESCRIPTION OF THE DRAWINGS

An exemplary embodiment of the present disclosure will be described in detail based on the following figures, wherein:

FIG. 1 is a block diagram illustrating an example of a printed-matter processing system according to the exemplary embodiment;

FIG. 2A illustrates a pressure adhesive toner used for a non-confidential-type printed matter;

FIG. 2B illustrates a pressure adhesive toner used for a confidential-type printed matter and an identification code added to the confidential-type printed matter; and

FIG. 3 is a schematic view illustrating the major part of a sealer in the exemplary embodiment and shows a state in which a folded printed matter is being transported to the sealer and sealed with the pressure adhesive toner.

### DETAILED DESCRIPTION

An exemplary embodiment of the disclosure will be described below with reference to the accompanying drawings.

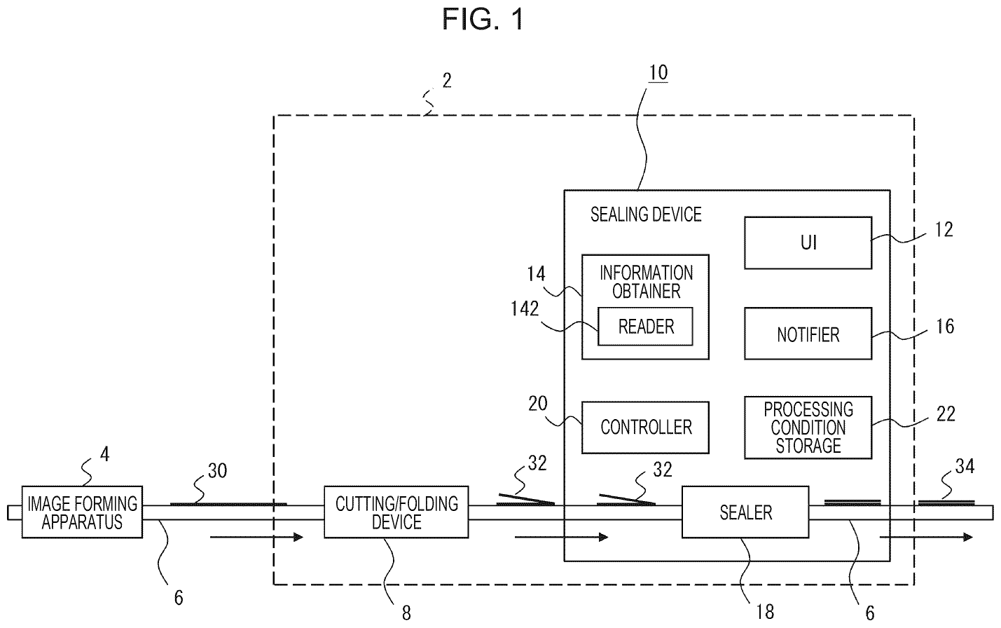

FIG. 1 is a block diagram illustrating an example of a printed-matter processing system 2 according to the exemplary embodiment. The printed-matter processing system 2 of the exemplary embodiment is a device that processes a printed matter 30 generated by an image forming apparatus 4 disposed at the previous stage. The image forming apparatus 4 is constituted by a production color printer, for example.

A pressure adhesive toner is attached to the surface of the printed matter 30 generated by the image forming apparatus 4. “Adhesive toner” is a special toner that exhibits an adhesive function when the pressure is applied thereto. More specifically, the adhesive toner is a colorless transparent toner in which a pressure-responsive resin is finely dispersed. The pressure-responsive resin is softened only when high pressure is applied thereto and exhibits the function of binding sheets with each other.

The printed-matter processing system 2 processes the printed matter 30 to bind its surfaces (inside pages) having a pressure adhesive toner attached thereto with each other, thereby generating a sealed document 34, such as a sealed postcard or a sealed envelope. Direct mail (DM) used for sales promotion, for example, is one mode of a sealed document generated by the printed-matter processing system 2.

The printed-matter processing system 2 includes a cutting/folding device 8 and a sealing device 10. To process the printed matter 30 transported from the image forming apparatus 4 along a transport path 6 to generate the sealed document 34, the cutting/folding device 8 executes a cutting step of cutting off an unnecessary portion from the printed matter 30 and a folding step of folding the cut printed matter 30, and the sealing device 10 executes a sealing step of sealing a folded printed matter 32 by applying pressure thereto. One of the major features of the exemplary embodiment is sealing processing control performed by the sealing device 10 for the printed matter 32.

The printed-matter processing system 2 can be added to the stage subsequent to a production color printer and has a built-in computer. The printed-matter processing system 2 thus includes a central processing unit (CPU), a read only memory (ROM), a random access memory (RAM), a hard disk drive (HDD) as a storage, a network interface as a communication medium, and an operation panel as a user interface, for example.

As illustrated in FIG. 1, the sealing device 10 includes a user interface (UI) 12, an information obtainer 14, a notifier 16, a sealer 18, a controller 20, and a processing condition storage 22. The components that are not used for an explanation of the exemplary embodiment are not shown.

The UI 12 is constituted by an operation panel and receives an instruction from a user and displays information. The information obtainer 14 obtains information, such as processing setting information supplied from an instruction device, such as an external server (not shown) or the image forming apparatus 4, or information input from the operation panel (UI 12). Specifically, information to be obtained by the information obtainer 14 are about the type of printed matter 30 and the processing conditions, for example. The information obtainer 14 includes a reader 142. If information for identifying the type of printed matter 30 is linked with the printed matter 30, the reader 142 identifies the type of printed matter 30 from the information. For example, the reader 142 may optically read this information. The notifier 16 has a notifying function, such as displaying a message on the operation panel and sending a message to an external device via a network. Specific notification processing performed by the notifier 16 will be discussed later.

The sealer 18 executes sealing processing for the folded printed matter 32 to be sealed. The controller 20 performs operation control for the components loaded in the printed-matter processing system 2. The controller 20 in the exemplary embodiment controls the adhesion force of the sealer 18 to seal the printed matter 32 in accordance with the type of printed matter 32. More specifically, the controller 20 controls sealing processing executed by the sealer 18 in accordance with the processing conditions set for the type of printed matter 32. The controller 20 may perform operation control for the components of the printed-matter processing system 2 in accordance with an instruction from a server, which is not shown, or the image forming apparatus 4.

The printed-matter processing system 2 processes the printed matter 30 in accordance with specified processing conditions. The processing conditions are supplied from a server, which is not shown, or the image forming apparatus 4, or are set for the sealing device 10 in advance. The processing condition storage 22 stores processing conditions set in the sealing device 10. The processing conditions stored in the processing condition storage 22 may be used as initial values. The processing condition storage 22 may also store processing conditions sent from an external device.

The cutting/folding device 8 and the sealing device 10 of the printed-matter processing system 2 are implemented by the cooperative operation of a computer loaded in the printed-matter processing system 2 and a program operated by a CPU installed in the computer. The program used in the exemplary embodiment may be provided via a communication medium or may be stored in a computer readable recording medium, such as a universal serial bus (USB) memory, and be provided. The program provided via the communication medium or the recording medium is installed in the computer. As a result of the CPU sequentially executing the program, various processing operations are implemented. The present disclosure may also be applicable to a program and a program product.

The sealing device 10 in the exemplary embodiment corresponds to a printed-matter sealing processing system according to an exemplary embodiment of the disclosure. The cutting/folding device 8 may include its own controller, which corresponds to the controller 20 of the sealing device 10, or may share the controller 20 with the sealing device 10.

In the exemplary embodiment, the printed-matter processing system 2 is constituted by a single device. However, the printed-matter processing system 2 may be constituted by multiple devices.

The operation in the exemplary embodiment will now be described below.

Printed matters 30 to be processed are sequentially transported from the image forming apparatus 4 to the printed-matter processing system 2 via the transport path 6. As stated above, the pressure adhesive toner is attached to each of the printed matters 30. The printed-matter processing system 2 is thus required to obtain information for identifying the type of each of the printed matters 30 before performing sealing processing at the latest.

In the exemplary embodiment, as the types of printed matters 30, two types, that is, a confidential type, which is a first type of printed matter 30, and a non-confidential type, which is a second type of printed matter 30, are generated by way of example. The type of printed matter 30 transported from the image forming apparatus 4 and the type of folded printed matter 32 are the same.

“Confidential” means that the sender of a sealed document wants the addressee to this sealed document to open it by himself/herself to read or should be treated as such. In the exemplary embodiment, “confidential type” is a printed matter 30 which is confidential as defined as described above and is the printed matter in general whose inside pages should not be disclosed to the third party to protect its confidentiality. For example, if a confidential-type printed matter 30 is a DM, it may be desirable to strengthen the adhesion force of this DM so that the adhesive surface does not accidentally peel off before the DM reaches the receiver. In contrast, in the exemplary embodiment, “non-confidential type” is printed matters 30 other than confidential-type printed matters 30. “Non-confidential type” is the printed matter in general that is not to be handled in privacy as strictly as “confidential type”. It may still be desirable that the adhesive surface of a non-confidential-type printed matter does not peel off. However, the degree for this demand is still lower than that for the confidential type.

For the above-described reason, it may be desirable to seal a confidential-type printed matter with a stronger adhesion force than a non-confidential-type printed matter so that the adhesive surface of the printed matter does not peel off. As will be discussed later, there are various approaches to obtaining information on the type of printed matter 30, that is, whether the printed matter 30 is the confidential type or the non-confidential type. For example, the type of printed matter 30 may be obtained from the image forming apparatus 4 as a processing instruction, that is, a processing condition, or may be input into the operation panel by a user. Alternatively, the sealing device 10 may obtain the type of printed matter 30 by itself, which will be explained below.

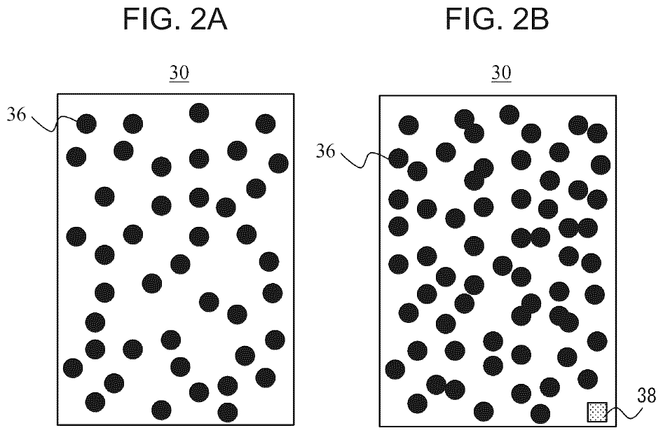

FIG. 2A illustrates an example of a non-confidential-type printed matter 30. FIG. 2B illustrates an example of a confidential-type printed matter 30. The sealing device 10 may obtain the type of printed matter 30 by itself by determining whether the printed matter 30 is the type shown in FIG. 2A or the type shown in FIG. 2B, for example. A pressure adhesive toner 36 is attached to both of the surface of the printed matter 30 in FIG. 2A and that in FIG. 2B. To strength the adhesion force, more particles of the pressure adhesive toner 36 are attached to the surface of the confidential type in FIG. 2B than to the non-confidential type in FIG. 2A.

As shown in FIG. 2B, a predetermined identification code 38 is added only to the surface of the confidential type. The identification code 38 is used to determine whether the printed matter 30 is the confidential type or the non-confidential type. The reader 142 searches for the identification code 38 on the surface of the printed matter 30 transported from the image forming apparatus 4. If the reader 142 detects the identification code 38, the controller 20 determines that the printed matter 30 is the confidential type. If the reader 142 fails to detect the identification code 38, the controller 20 determines that the printed matter 30 is the non-confidential type.

In the exemplary embodiment, the type of printed matter 30 is identified from information linked with the printed matter 30, that is, the identification code 38 in the example in FIG. 2B. However, this is only an example, and the type of printed matter 30 may be determined by another approach.

For example, the identification code 38 may be added to all printed matters 30, and it may be determined whether each of the printed matters 30 is the confidential type or the non-confidential type in accordance with the content of code data set for the identification code 38. With this approach, the disclosure is applicable to three or more types of printed matters 30. The identification code 38 may not necessarily be added to the adhesive surface of the printed matter 30. The type of printed matter 30 may be determined depending on the position of the identification code 38 added to the printed matter 30. The cutting/folding device 8 cuts off an unnecessary portion from the printed matter 30 in the cutting step, and if the identification code 38 is added to a portion to be removed, the sealed document 34 does not include the identification code 38.

The identification code 38 is added by the image forming apparatus 4. If the image forming apparatus 4 does not such an adding function, a user may specify the type of printed matter 30.

For example, the controller 20 displays a screen for allowing a user to select whether the type of printed matter 30 is the confidential type or the non-confidential type on the UI 12, that is, the operation panel. The user then makes this selection on the operation panel.

As described above, the sealing device 10 may obtain processing setting information from an instruction device (the above-described server or the image forming apparatus 4). In this case, if this processing setting information indicates the type of printed matter 30 as well as other information, the sealing device 10 may determine the type of printed matter 30 by referring to the processing setting information.

The cutting/folding device 8 cuts the printed matter 30 in accordance with the processing conditions. The cutting/folding device 8 also folds the printed matter 30 in accordance with the processing conditions. Like the type of printed matter 30, the processing conditions for the cutting/folding device 8 may be set by a user using the operation panel, or the processing conditions stored in the processing condition storage 22 may be used. Alternatively, if the processing conditions are included in the processing setting information sent from the instruction device, they may be used.

Regarding the types of folding for the printed matter 30, typical examples are single fold, letter-fold (C-fold), and Z-fold for sealed postcards and are letter-fold (C-fold) and Z-fold for sealed envelopes.

After the printed matter 30 is cut and folded, the controller 20 executes sealing processing for the folded printed matter 32 in accordance with the processing conditions set for the identified type of printed matter 30.

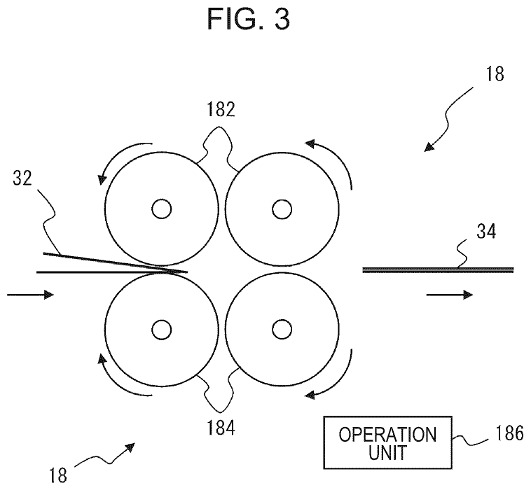

FIG. 3 is a schematic view illustrating the major part of the sealer 18 in the exemplary embodiment and shows a state in which the folded printed matter 32 is being transported to the sealer 18 and sealed. As illustrated in FIG. 3, the sealer 18 includes heating rollers 182, pressurizing rollers 184, and an operation unit 186 that drives the heating rollers 182 and the pressurizing rollers 184 and also controls the temperature and the pressure. In FIG. 3, one pair of heating rollers 182 and one pair of pressurizing rollers 184 are provided by way of example. In the exemplary embodiment, a typical hardware configuration is used for the sealer 18, though the controller 20 controls the heating rollers 182, pressurizing rollers 184, and operation unit 186 in a specific manner.

The printed matter 32 folded by the cutting/folding device 8 is transported to between the heating rollers 182 and the pressurizing rollers 184. The pressure adhesive toner attached to the inside pages of the printed matter 32 exhibits the adhesive function by the heat of the heating rollers 182 and the pressure of the pressurizing rollers 184 while the printed matter 32 is being transported between the heating rollers 182 and the pressurizing rollers 184. As a result, the printed matter 32 is sealed.

The controller 20 in the exemplary embodiment controls the sealing capability of the sealer 18 in accordance with the type of printed matter 32. As one of the measures to control the sealing capability, the controller 20 controls the temperature of the heating rollers 182.

As discussed above, if the printed matter 32 is the confidential type, it requires a strong adhesion force than the non-confidential type so that the adhesive surface is less likely to peel off. Hence, the controller 20 performs control so that the heating rollers 182 apply a higher temperature to the pressure adhesive toner of the confidential type than to the non-confidential type. For example, if the temperature set for the non-confidential-type printed matter 32 is 150° C. to 200° C., a higher temperature, for example, 200° C. to 250° C., is set for the confidential-type printed matter 32 in accordance with the processing conditions. With this range of temperatures of the heating rollers 182, the pressure adhesive toner can soften by heat and exhibit the adhesive function. To raise the temperature of the heating rollers 182 means to apply a higher temperature to the pressure adhesive toner. This makes it possible to seal the confidential-type printed matter 32 more tightly than the non-confidential-type printed matter 32.

As another measure to control the sealing capability of the sealer 18, the controller 20 may control the pressure of the pressurizing rollers 184 applied to the printed matter 32. This will be explained more specifically. As a result of shifting the pressurizing rollers 184 toward the heating rollers 182 (upward direction in FIG. 3), the pressure applied to the printed matter 32 can be elevated. Hence, the controller 20 performs control so that the pressurizing rollers 184 can apply a higher pressure to the confidential-type printed matter 32 than to the non-confidential-type printed matter 32. For example, if the pressure set for the non-confidential-type printed matter 32 is 500 to 900 Kg, a higher pressure, for example, 1000 to 1500 Kg, is set for the confidential-type printed matter 32 in accordance with the processing conditions. Increasing the pressure applied to the printed matter 32 can more closely bind the particles of the pressure adhesive toner attached to the inside pages of the printed matter 32. This makes it possible to seal the confidential-type printed matter 32 more tightly than the non-confidential-type printed matter 32.

The controller 20 in the exemplary embodiment may control the transport speed of the printed matter 32 transported between the heating rollers 182 and the pressurizing rollers 184 in accordance with the type of printed matter 32.

As discussed above, it may be desirable to seal a confidential-type printed matter with a stronger adhesion force than a non-confidential-type printed matter so that the adhesive surface does not peel off. Hence, the controller 20 performs control so that the transport speed of a confidential-type printed matter 32 becomes lower than that of a non-confidential-type printed matter 32. For example, if the transport speed set for the non-confidential-type printed matter 32 is 200 to 400 mm/s, a lower transport speed, for example, 100 to 200 mm/s, is set for the confidential-type printed matter 32 in accordance with the processing conditions. Decreasing the transport speed can apply the pressure to the confidential-type printed matter 32 for a longer time than to the non-confidential-type printed matter 32. This makes it possible to seal the confidential-type printed matter 32 more tightly than the non-confidential-type printed matter 32.

As described above, in the exemplary embodiment, the sealing capability of the sealer 18 can be controlled in accordance with the type of printed matter 32. It is thus possible to more tightly seal the confidential-type printed matter 32, which requires a stronger adhesion force for a resulting sealed document 34, than the non-confidential-type printed matter 32.

As discussed above, if the printed matter 32 is the confidential type, to set a higher adhesion force to be applied to the printed matter 32 than to the non-confidential type, the image forming apparatus 4 may adjust the amount of pressure adhesive toner to be attached to the printed matter 30, as illustrated in FIG. 2B. That is, a greater amount of toner may be attached to the confidential type than to the non-confidential type. Even if the same amount of pressure adhesive toner is attached to the printed matter 30 regardless of its type, the sealing capability of the sealer 18 can be controlled as discussed above, thereby making it possible to apply a stronger adhesion force to the confidential type than to the non-confidential type.

In the processing condition storage 22 of the sealing device 10, the processing conditions are preset by the type of printed matter 30. In the above-described examples, the processing conditions of the sealing device 10 for the non-confidential type are set such that the temperature of the heating rollers 182 is 150° C. to 200° C., the pressure to be applied to the printed matter 32 by the pressurizing rollers 184 is 500 to 900 Kg, and the transport speed of the printed matter 32 is 200 to 400 mm/s. The processing conditions of the sealing device 10 for the confidential type are set such that the temperature of the heating rollers 182 is 200° C. to 250° C., the pressure to be applied to the printed matter 32 by the pressurizing rollers 184 is 1000 to 1500 Kg, and the transport speed of the printed matter 32 is 100 to 200 mm/s. Since these processing conditions are prestored in the processing condition storage 22, they are basically parameter values that can make the sealing device 10 operable.

In contrast, with the processing conditions obtained from an external instruction device, the sealing device 10 may malfunction for reasons, such as setting errors for parameter values or information sent to a wrong receiver.

If the controller 20 determines that the sealing device 10 is unable to function properly with the processing conditions obtained from the external instruction device, it causes the notifier 16 to notify this information to the instruction device. That is, the notifier 16 sends the instruction device a message indicating that the sealing device 10 is unable to function properly based on the received processing conditions. The notifier 16 may alternatively display such information on the operation panel or record it as a log.

If, in response to such a message, the information obtainer 14 receives a change made to the processing conditions sent from the instruction device or if the UI 12 receives a change made to the processing conditions input from the operation panel, that is, if modified processing conditions are received, the controller 20 controls the operation of the sealer 18 based on the changed processing conditions.

If the sealing device 10 obtains the processing conditions for a printed matter 30 from the instruction device, the controller 20 obtains the processing conditions from the processing condition storage 22 in accordance with the type of this printed matter 30. Then, the controller 20 checks the two types of processing conditions against each other. If the two types of processing conditions do not match each other, the controller 20 determines that the processing conditions obtained from the instruction device may be inappropriate and causes the notifier 16 to notify this information to the instruction device. In this manner, the controller 20 may cause the instruction device to check whether the processing conditions are suitable and, if the processing conditions are not suitable, it may cause the instruction device to change the processing conditions and to send them again, as discussed above.

The parameter values of the above-described two types of processing conditions may not necessarily match each other. For example, if a certain range of parameter values is set in the processing condition storage 22, for instance, if the temperature of the heating rollers 182 for the confidential type is 200° C. to 250° C., as long as the parameter value represented by a certain processing condition obtained from the instruction device is included within this range, it may be determined that the processing conditions obtained from the instruction device match those stored in the processing condition storage 22.

As described above, in the exemplary embodiment, it is possible to control the adhesion force used to process a printed matter in accordance with the type of printed matter.

In the exemplary embodiment, printed matters are divided into two types, namely, the confidential type and the non-confidential type, in accordance with the content of information to be printed. However, printed matters may be divided into three or more types by using another index. In this case, sealing processing is executed for a printed matter with the adhesion force set for the corresponding classified type of this printed matter.

The type of printed matter may not necessarily be determined based on information described in the printed matter. For example, printed matters may be divided into two or more types based on the properties of a print medium, for example, the type of paper, such as the thickness or the material of the print medium.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### (Appendix)

(((1)))

A printed-matter sealing processing system comprising:
a processor configured to:
   obtain a type of a printed matter to be sealed, the printed matter having being folded, a pressure adhesive toner being attached to the printed matter and exhibiting an adhesive function when pressure is applied to the pressure adhesive toner; and
   control an adhesion force to be applied when sealing the printed matter, in accordance with the obtained type of the printed matter.
      (((2)))

The printed-matter sealing processing system according to (((1))), further comprising:
a sealing device that executes sealing processing for the printed matter,
wherein the processor is configured to control the sealing device in accordance with a processing condition set for the obtained type of the printed matter.
   (((3)))

The printed-matter sealing processing system according to (((2))), wherein the processor is configured to control the sealing device in accordance with the processing condition so that a pressurizing roller included in the sealing device applies a higher pressure to a first type of printed matter than to a second type of printed matter, the first type of printed matter requiring a stronger adhesion force than the second type of printed matter.

(((4)))

The printed-matter sealing processing system according to (((2))), wherein the processor is configured to control the sealing device in accordance with the processing condition so that a heating roller included in the sealing device applies a higher temperature to a first type of printed matter than to a second type of printed matter, the first type of printed matter requiring a stronger adhesion force than the second type of printed matter.

(((5)))

The printed-matter sealing processing system according to (((2))), wherein the processor is configured to control the sealing device in accordance with the processing condition so that a transport speed of a first type of printed matter transported between a heating roller and a pressurizing roller included in the sealing device becomes lower than the transport speed of a second type of printed matter transported between the heating roller and the pressurizing roller, the first type of printed matter requiring a stronger adhesion force than the second type of printed matter.

(((6)))

The printed-matter sealing processing system according to one of (((3))) to (((5))), wherein:
the first type is a confidential type; and
the second type is a non-confidential type, which is other than the confidential type.
   (((7)))

The printed-matter sealing processing system according to one of (((1))) to (((6))), further comprising:
a sealing device that executes sealing processing for the printed matter,
wherein the processor is configured to control the sealing device in accordance with a processing condition indicated by processing setting information obtained from an instruction device.
   (((8)))

The printed-matter sealing processing system according to (((7))), wherein the processor is configured to, if the sealing device is unable to operate in accordance with the processing condition, notify the instruction device that the sealing device is unable to operate in accordance with the processing condition.

(((9)))

The printed-matter sealing processing system according to (((7))), wherein the processor is configured to, if the sealing device is unable to operate in accordance with the processing condition,
receive a change made to the processing condition, and
control the sealing device in accordance with the changed processing condition.
   (((10)))

The printed-matter sealing processing system according to (((7))), wherein the processor is configured to:
obtain a processing condition set for the type of the printed matter from a plurality of preset processing conditions, the type of the printed matter being indicated by the processing setting information; and
notify the instruction device, if the obtained processing condition and the processing condition indicated by the processing setting information do not match each other, that the obtained processing condition and the processing condition indicated by the processing setting information do not match each other.
   (((11)))

The printed-matter sealing processing system according to one of (((1))) to (((10))), wherein the processor is configured to identify the type of the printed matter from information linked with the printed matter.

(((12)))

A program causing a computer to execute a process, the process comprising:
obtaining a type of a printed matter to be sealed, the printed matter having being folded, a pressure adhesive toner being attached to the printed matter and exhibiting an adhesive function when pressure is applied to the pressure adhesive toner; and
controlling an adhesion force to be applied when sealing the printed matter, in accordance with the obtained type of the printed matter.

What is claimed is:

1. A printed-matter sealing processing system comprising:
a processor configured to:
obtain a type of a printed matter to be sealed, the printed matter having being folded, a pressure adhesive toner being attached to the printed matter and exhibiting an adhesive function when pressure is applied to the pressure adhesive toner; and
control an adhesion force to be applied when sealing the printed matter, in accordance with the obtained type of the printed matter.

2. The printed-matter sealing processing system according to claim 1, further comprising:
a sealing device that executes sealing processing for the printed matter,
wherein the processor is configured to control the sealing device in accordance with a processing condition set for the obtained type of the printed matter.

3. The printed-matter sealing processing system according to claim 2, wherein the processor is configured to control the sealing device in accordance with the processing condition so that a pressurizing roller included in the sealing device applies a higher pressure to a first type of printed matter than to a second type of printed matter, the first type of printed matter requiring a stronger adhesion force than the second type of printed matter.

4. The printed-matter sealing processing system according to claim 2, wherein the processor is configured to control the sealing device in accordance with the processing condition so that a heating roller included in the sealing device applies a higher temperature to a first type of printed matter than to a second type of printed matter, the first type of printed matter requiring a stronger adhesion force than the second type of printed matter.

5. The printed-matter sealing processing system according to claim 2, wherein the processor is configured to control the sealing device in accordance with the processing condition so that a transport speed of a first type of printed matter transported between a heating roller and a pressurizing roller included in the sealing device becomes lower than the transport speed of a second type of printed matter transported between the heating roller and the pressurizing roller, the first type of printed matter requiring a stronger adhesion force than the second type of printed matter.

6. The printed-matter sealing processing system according to claim 3, wherein:
the first type is a confidential type; and
the second type is a non-confidential type, which is other than the confidential type.

7. The printed-matter sealing processing system according to claim 4, wherein:
the first type is a confidential type; and
the second type is a non-confidential type, which is other than the confidential type.

8. The printed-matter sealing processing system according to claim 5, wherein:
the first type is a confidential type; and
the second type is a non-confidential type, which is other than the confidential type.

9. The printed-matter sealing processing system according to claim 1, further comprising:
a sealing device that executes sealing processing for the printed matter,
wherein the processor is configured to control the sealing device in accordance with a processing condition indicated by processing setting information obtained from an instruction device.

10. The printed-matter sealing processing system according to claim 9, wherein the processor is configured to, if the sealing device is unable to operate in accordance with the processing condition, notify the instruction device that the sealing device is unable to operate in accordance with the processing condition.

11. The printed-matter sealing processing system according to claim 9, wherein the processor is configured to, if the sealing device is unable to operate in accordance with the processing condition,
receive a change made to the processing condition, and
control the sealing device in accordance with the changed processing condition.

12. The printed-matter sealing processing system according to claim 9, wherein the processor is configured to:
obtain a processing condition set for the type of the printed matter from a plurality of preset processing conditions, the type of the printed matter being indicated by the processing setting information; and
notify the instruction device, if the obtained processing condition and the processing condition indicated by the processing setting information do not match each other, that the obtained processing condition and the processing condition indicated by the processing setting information do not match each other.

13. The printed-matter sealing processing system according to claim 1, wherein the processor is configured to identify the type of the printed matter from information linked with the printed matter.

14. A printed-matter sealing processing method comprising:
obtaining a type of a printed matter to be sealed, the printed matter having being folded, a pressure adhesive toner being attached to the printed matter and exhibiting an adhesive function when pressure is applied to the pressure adhesive toner; and
controlling an adhesion force to be applied when sealing the printed matter, in accordance with the obtained type of the printed matter.

15. A non-transitory computer readable medium storing a program causing a computer to execute a process, the process comprising:
obtaining a type of a printed matter to be sealed, the printed matter having being folded, a pressure adhesive toner being attached to the printed matter and exhibiting an adhesive function when pressure is applied to the pressure adhesive toner; and
controlling an adhesion force to be applied when sealing the printed matter, in accordance with the obtained type of the printed matter.
